(19) United States
(12) Patent Application Publication
(10) Pub. No.: US 2024/0427604 A1
(43) Pub. Date: Dec. 26, 2024

(54) PIPELINE SELECTION FOR MACHINE LEARNING MODEL BUILDING

(71) Applicant: International Business Machines Corporation, Armonk, NY (US)

(72) Inventors: Chandrasekhara K. Reddy, Kinnelon, NJ (US); Yuhan Shao, Yorktown Heights, NY (US); Dhavalkumar C. Patel, White Plains, NY (US); Jayant R. Kalagnanam, Briarcliff Manor, NY (US); Anuradha Bhamidipaty, Yorktown Heights, NY (US)

(21) Appl. No.: 18/341,120

(22) Filed: Jun. 26, 2023

(51) Int. Cl. G06F 9/38

(52) U.S. Cl. CPC G06F 9/3861; G06F 9/3869

(57) ABSTRACT

Machine learning (ML) pipeline selection includes performing cross-validation runs for dataset-pipeline combinations and building a matrix of first accuracy scores, factoring the matrix of accuracy scores into pipeline latent factors and dataset latent factors, augmenting the matrix of accuracy scores by selecting a subset of ML pipelines of a plurality of ML pipelines, then, for a new dataset, running the subset of ML pipelines with the new dataset to build and test respective ML models, obtain second accuracy scores, and augment the matrix of accuracy scores with the second accuracy scores to produce an augmented matrix of accuracy scores, factoring the augmented matrix of accuracy scores into refined pipeline latent factors and refined dataset latent factors, and identifying, based on the refined pipeline latent factors and the refined dataset latent factors, ML pipeline(s), of the plurality of ML pipelines, as most optimal for model building based on the new dataset.

### BACKGROUND

This disclosure relates generally to machine learning-based artificial intelligence model generation, and more particularly to selection of machine learning pipeline(s) to use in generating machine learning models.

In an automated machine learning setting in which numerous machine learning pipelines are available for use in generating an appropriate machine learning-based artificial intelligence model, some machine learning pipelines might perform better than others in terms of the models produced. It may be desired to determine, for a given dataset, which one or more of the available pipelines perform the best in terms of accuracy (or other metric(s)) of the machine learning model produced for that dataset. One approach is to run the dataset through all of the available pipelines and then select the best pipeline to use based on, e.g., the accuracy scores of the resulting models. Such an approach quickly becomes prohibitive as the number of available pipelines increases. Since it is not uncommon to have hundreds or thousands of available pipelines in an automated machine learning setting, the brute force approach of running the dataset through all of the available pipelines is not practical.

### SUMMARY

Shortcomings of the prior art are overcome and additional advantages are provided through the provision of a computer-implemented method. The method performs cross-validation runs for a plurality of dataset-pipeline combinations combined from a plurality of datasets and a plurality of machine learning pipelines, and builds from the cross-validation runs a matrix of accuracy scores. The accuracy scores are first accuracy scores and include a respective accuracy score for each dataset-pipeline combination of the plurality of dataset-pipeline combinations. The method also factors the matrix of accuracy scores into pipeline latent factors and dataset latent factors. The method additionally augments the matrix of accuracy scores. The augmenting includes selecting a subset of machine learning pipelines of the plurality of machine learning pipelines. The augmenting also includes, for a new dataset, running the subset of machine learning pipelines with the new dataset to build and test respective machine learning models, and obtaining second accuracy scores for combinations of the new dataset and the subset of machine learning pipelines, and then augmenting the matrix of accuracy scores with the second accuracy scores reflected for the new dataset to produce an augmented matrix of accuracy scores. Additionally, the method factors the augmented matrix of accuracy scores into refined pipeline latent factors and refined dataset latent factors. Further, the method identifies, based on the refined pipeline latent factors and the refined dataset latent factors, at least one machine learning pipeline, of the plurality of machine learning pipelines, as most optimal for model building based on the new dataset. The method, which selects machine learning pipeline(s) for use in building machine learning model(s), has an advantage in that it can identify, with relative ease based on historical data and selected pipeline runs on a new dataset, optimal pipeline options to use for the new dataset and selection of a best pipeline therefrom, which avoids the potentially cost/resource-prohibitive task of running the dataset through all available pipelines to determine an optimal pipeline to use.

Additionally, a computer system is provided that includes a memory and a processor in communication with the memory. The computer system is configured to perform a method that performs cross-validation runs for a plurality of dataset-pipeline combinations combined from a plurality of datasets and a plurality of machine learning pipelines, and builds from the cross-validation runs a matrix of accuracy scores. The accuracy scores are first accuracy scores and include a respective accuracy score for each dataset-pipeline combination of the plurality of dataset-pipeline combinations. The method also factors the matrix of accuracy scores into pipeline latent factors and dataset latent factors. The method additionally augments the matrix of accuracy scores. The augmenting includes selecting a subset of machine learning pipelines of the plurality of machine learning pipelines. The augmenting also includes, for a new dataset, running the subset of machine learning pipelines with the new dataset to build and test respective machine learning models, and obtaining second accuracy scores for combinations of the new dataset and the subset of machine learning pipelines, and then augmenting the matrix of accuracy scores with the second accuracy scores reflected for the new dataset to produce an augmented matrix of accuracy scores. Additionally, the method factors the augmented matrix of accuracy scores into refined pipeline latent factors and refined dataset latent factors. Further, the method identifies, based on the refined pipeline latent factors and the refined dataset latent factors, at least one machine learning pipeline, of the plurality of machine learning pipelines, as most optimal for model building based on the new dataset. The computer system has an advantage in that it identifies with relative ease based on historical data and selected pipeline runs on a new dataset optimal pipeline options to use for the new dataset and selection of a best pipeline therefrom, which avoids the potentially cost/resource-prohibitive task of running the dataset through all available pipelines to determine an optimal one to use. The computer system, in which the subject method selects machine learning pipeline(s) for use in building machine learning model(s), has an advantage in that it can identify, with relative ease based on historical data and selected pipeline runs on a new dataset, optimal pipeline options to use for the new dataset and selection of a best pipeline therefrom, which avoids the potentially cost/resource-prohibitive task of running the dataset through all available pipelines to determine an optimal pipeline to use.

Further, a computer program product is provided that includes a computer readable storage medium readable by a processing circuit and storing instructions for execution by the processing circuit to perform a method. The method that performs cross-validation runs for a plurality of dataset-pipeline combinations combined from a plurality of datasets and a plurality of machine learning pipelines, and builds from the cross-validation runs a matrix of accuracy scores. The accuracy are first accuracy scores that include a respective accuracy score for each dataset-pipeline combination of the plurality of dataset-pipeline combinations. The method also factors the matrix of accuracy scores into pipeline latent factors and dataset latent factors. The method additionally augments the matrix of accuracy scores. The augmenting includes selecting a subset of machine learning pipelines of the plurality of machine learning pipelines. The augmenting also includes, for a new dataset, running the subset of machine learning pipelines with the new dataset to build and test respective machine learning models, and obtaining second accuracy scores for combinations of the new dataset and the subset of machine learning pipelines, and then augmenting the matrix of accuracy scores with the second accuracy scores reflected for the new dataset to produce an augmented matrix of accuracy scores. Additionally, the method factors the augmented matrix of accuracy scores into refined pipeline latent factors and refined dataset latent factors. Further, the method identifies, based on the refined pipeline latent factors and the refined dataset latent factors, at least one machine learning pipeline, of the plurality of machine learning pipelines, as most optimal for model building based on the new dataset. The computer program product, in which the subject method selects machine learning pipeline(s) for use in building machine learning model(s), has an advantage in that it can identify, with relative ease based on historical data and selected pipeline runs on a new dataset, optimal pipeline options to use for the new dataset and selection of a best pipeline therefrom, which avoids the potentially cost/resource-prohibitive task of running the dataset through all available pipelines to determine an optimal pipeline to use.

In some embodiments, the selected subset of machine learning pipelines includes the k highest-performing machine learning pipelines based on the accuracy scores of combinations of those machine learning pipelines with datasets of the plurality of datasets, which has an advantage in that it provides the process a balanced starting point for trial pipeline runs using a new dataset, stemming this from the highest performing pipeline(s) as an early focus on the potentially optimal pipeline to ultimately select, and does this based on historical performance of the pipelines but without eliminating from consideration the non-selected pipelines.

In any of the foregoing, and/or alternative embodiments, the factoring the augmented matrix of accuracy scores includes using an objective function that includes a loss function and regularization penalty, which has an advantage in that it enables a focus on reaching an overall objective while balancing loss and regularization. In examples, the regularization penalty includes a similarity term and the similarity term is a function of (i) dataset similarity between datasets and (ii) distance between latent factors of the refined dataset latent factors, where greater similarity results in a lower latent factor distance and lesser similarity results in a higher latent factor distance, which has an advantage in that it provides a check on the latent factors determined for the datasets to ensure consistency as between the latent factors when there is consistency (similarity) as between the datasets. In examples, the dataset similarity is determined using canonical correlation analysis which has an advantage of using a well-known analysis that provides a straightforward assessment of dataset similarity. In examples, the distance between latent factors includes (is determined as) a Euclidean distance, which has an advantage in that it provides a straightforward way to compare latent factors involved.

In any of the foregoing, and/or alternative embodiments, the method further includes building and outputting a machine learning model using a selected machine learning pipeline of the at least one machine learning pipeline, which has advantages in that such generation of the machine learning model may be difficult computationally or otherwise, and/or it provides additional optimization opportunities, for instance through tailoring pipeline parameters or similar actions to build and provide the ML model, which may not fit within the expertise of an entity requesting the ML model based on the new dataset, which might have been provided by that entity. In examples, the selected machine learning pipeline is selected based on a time and compute budget, which has an advantage in that it enables the process to account for the varying costs to run the different pipelines in terms of time and/or compute resources, and better identify what is/are the ‘optimum’ pipeline(s) as a function of not only pipeline accuracy but also the available time/compute resources for the particular task.

In any of the foregoing, and/or alternative embodiments, the identifying the at least one machine learning pipeline includes validating results for the at least one machine learning pipeline. The validating the results includes at least one selected from the group consisting of: clustering the plurality of machine learning pipelines into pipeline clusters and verifying similarity of clustered pipelines, and clustering the plurality of datasets and new dataset into dataset clusters and verifying similarity of clustered datasets, which has an advantage in that clustering can help verify which dataset(s) are most similar to the new dataset for a pipeline to be selected.

The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example conceptual representation of cross-validation runs for dataset-pipeline combinations and accuracy score matrix building based thereon, in accordance with aspects described herein;

FIGS. 3A and 3B depict an example of accuracy score matrix factoring and augmentation, in accordance with aspects described herein;

FIG. 4 depicts an example conceptual comparison of optimizer performance in factoring an accuracy matrix into dataset and pipeline latent factors, in accordance with aspects described herein;

FIG. 5 depicts an example clustering of pipelines based on performance to conceptually inform of and verify similarities between pipelines, in accordance with aspects described herein;

FIG. 6 depicts further details of an example pipeline selection module to incorporate and/or use aspects described herein; and

FIG. 7 depicts an example process for selecting machine learning pipeline(s) for use in building machine learning model(s), in accordance with aspects described herein.

### DETAILED DESCRIPTION

Described herein are approaches for selecting machine learning (ML) pipelines for use in building machine learning models. The performance of multiple pipelines on different datasets may be used to estimate the performance of those pipelines, and additional pipelines of a larger collection of available pipelines, for a given dataset at hand. The given dataset could be, for instance, a new dataset, such as one that was not previously run through the pipelines, for instance a new dataset presented by an entity requesting identification of a pipeline to use and/or an ML model to be built by running the dataset through one of the available pipelines. The performance information of the multiple pipelines could be information that is already available from prior-performed runs of existing, historical datasets through those pipelines and saved results of those runs.

One approach is to use this available information about the performance of pipelines on several datasets for an estimate of the performance of those pipelines for a given dataset. As part of this, a process can determine a top k number of pipelines (e.g., 1 or more) and generating an ML model using the new dataset by running the new dataset through the pipeline(s). k can depend on defined parameters. In embodiments, available resources and/or a budget of those resources, such as a time and compute budget, to run the dataset through the pipeline(s) serve as parameters of the selection of the k pipeline(s) and/or selection of a best pipeline to use, for instance the pipeline that produces the best (most accurate) ML model given the resources available.

In this manner, processes are provided for automatically identifying and/or selecting a pipeline (or pipelines) to use in building ML model(s) from a given dataset from a larger collection of machine learning pipelines available for use. This can help bring automation across multiple assets (e.g., pipelines, datasets) for improved and efficient ML model training, building, generating, validating, etc., providing an advantage in that it enables AI model factories to quickly and accurately scale while maintaining integrity in producing highly accurate models across different datasets and for varying pipeline options and customer needs.

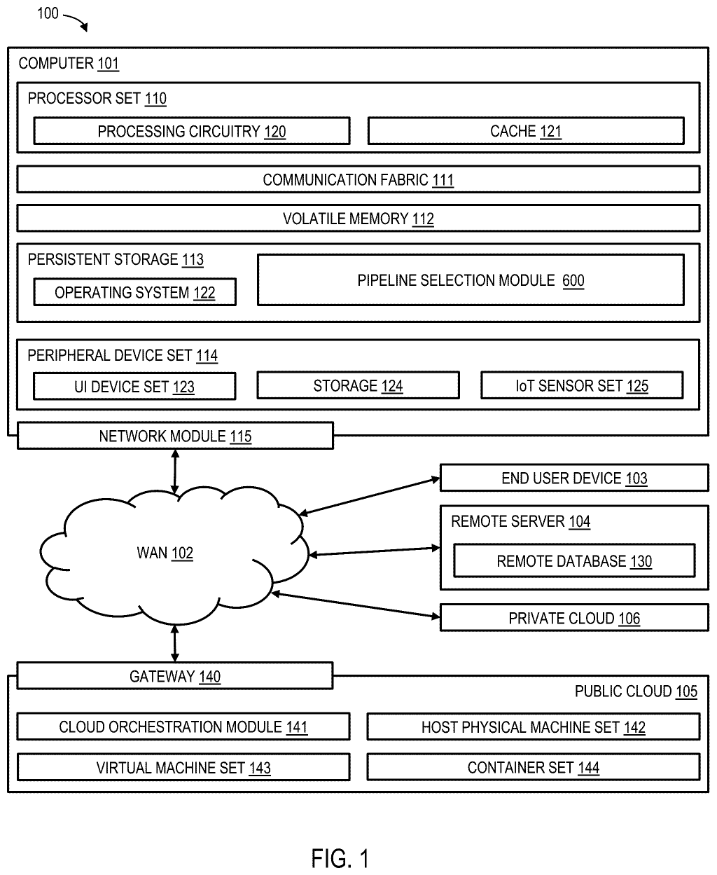

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing aspects of the present disclosure, such as code of pipeline selection module 600. In addition to block 600, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 600, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 121 and the other storage media discussed below. The program instructions, and associated data, are accessed by processor set 110 to control and direct performance of the disclosed methods. In computing environment 100, at least some of the instructions for performing the disclosed methods may be stored in block 600 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 600 typically includes at least some of the computer code involved in performing the disclosed methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the disclosed methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

Provided herein are computer-implemented methods to select, based on a given dataset, a machine learning pipeline for use in building (e.g., generating, training, verifying, etc.) a machine learning model using the dataset.

In accordance with some aspects, matrix factorization is leveraged in solving the problem of pipeline selection. Initially, a method performs cross-validation runs for a plurality of dataset-pipeline combinations that are combined from a plurality of datasets and a plurality of available machine learning pipelines. Each dataset-pipeline combination include one dataset and one pipeline, the dataset having been run through the pipeline to produce a machine learning model. In examples, the datasets are historical datasets that have previously been run through one or more of the plurality of available pipeline(s), and therefore these cross-validation runs have been performed (they do not need to be run again) and their results are known. The method in this regard may encompass such activity. Example results include accuracies of the ML models produced from the runs, the accuracies being measured by testing the resulting ML models. In examples, each cross-validation run includes a run of a respective dataset through a respective machine learning model pipeline (a dataset-pipelines combination), the pipeline being used to build a respective ML model that is tested for accuracy. Several cross-validation runs could be performed for each such dataset-pipeline combination. From these cross-validation runs, a matrix (“M”) of accuracy scores is built. The matrix of accuracy scores includes a respective accuracy score for each dataset-pipeline combination of the plurality of dataset-pipeline combinations. In specific examples where more than one cross-validation run is performed on a given dataset-pipeline combination, then the results of each run (e.g., a respective accuracy score of the ML model produced from each run) can be averaged or composited in any other desired manner to produce an overall accuracy score for that dataset-pipeline combination, and this overall accuracy score for that dataset-pipeline combination may be the respective accuracy score presented for that dataset-pipeline combination in the matrix.

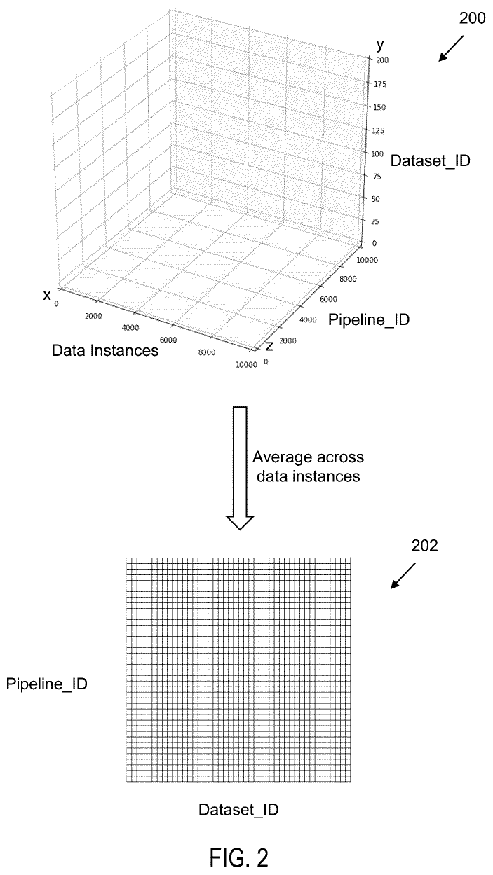

To illustrate, FIG. 2 depicts an example conceptual representation of cross-validation runs for dataset-pipeline combinations and accuracy score matrix building based thereon, in accordance with aspects described herein. Referring to FIG. 2, data cube 200 represents datapoints as results (e.g., ML model performance accuracies) for each run, in which the z-axis indicates the various different available pipelines, the y-axis represents the various different datasets, collectively a z-axis value and y-axis value pair denotes a given dataset-pipeline combination, and the x-axis represents a third dimension for the number of runs performed for each dataset-pipeline combination. Each datapoint in the cube corresponds to a run and can be a result, such as an accuracy score of the ML model, for that run. As noted, the method that performs the cross-validation runs could have performed the runs over time and built a history of runs and their results. It is common for an organization to historically (over time) acquire datasets and run those through pipeline(s), producing results, metrics, scores, or similar data and information about those runs. It is possible that all, most, or just some of the datapoints of data cube 200 are already available to process as described herein, and in this manner, the performance of the multiple pipelines could be information that is already available based on running existing, historical datasets through those pipelines and saving the information about those runs. It is noted, however, that a process could initiate runs of targeted dataset-pipeline combination(s) to produce results that go into building the matrix, if desired, for instance to produce a sufficient or desired minimum number of datapoints for one or more of the dataset-pipeline combinations.

As noted, from these cross-validation runs a matrix M of accuracy scores (‘first accuracy scores’) is built and includes a respective accuracy score for each dataset-pipeline combination of the plurality of dataset-pipeline combinations. Referring to FIG. 2, a function averages the individual accuracy scores of each dataset-pipeline combination reflected by 200 to produce a two-dimensional matrix M 202 of first accuracy scores. In FIG. 2, each row of the matrix 202 corresponds to a respective unique pipeline of the plurality of available pipelines and each column corresponds to a respective unique dataset of the plurality of datasets represented.

The plurality of pipelines included may have been selected from a larger collection based on desired goal(s) for the ML model ultimately to be produced for a new dataset. ML models can differ in their use or purpose. Some may be for anomaly detection, while others may be for failure prediction, and yet others may be for regression analysis, as examples. The desired ML model type therefore might dictate the ML pipelines or the larger collection, to include in the cross-validation runs/data sample (such as cube 200).

By averaging the accuracy scores across the data instances for each given dataset-pipeline combination, this results in a conceptual ‘flattening’ of the cube 200 into a two-dimensional matrix M (202) holding average accuracies for each dataset-pipeline combination.

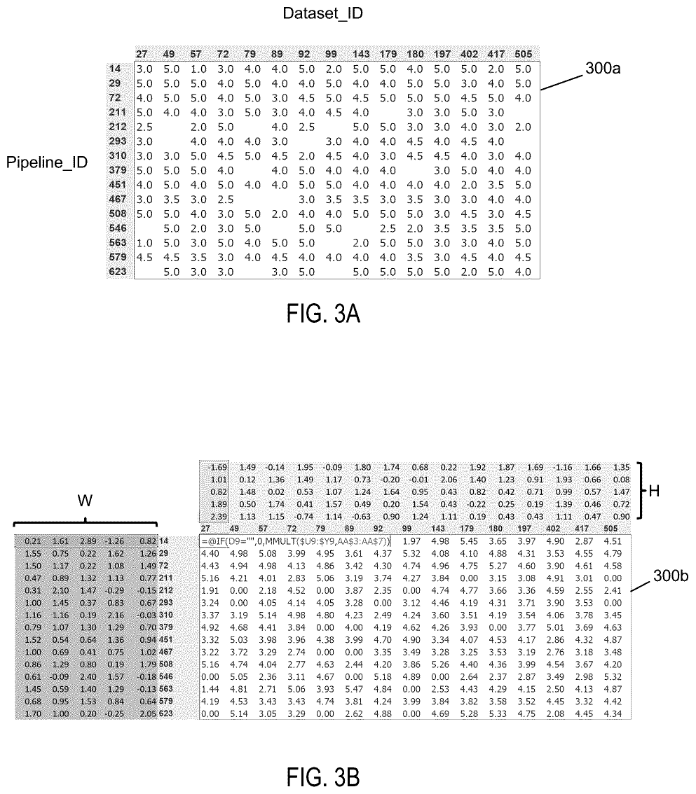

FIGS. 3A and 3B depict an example of accuracy score matrix factoring and augmentation, in accordance with aspects described herein. Matrix 300a is an example matrix M of first accuracy scores. The first (upper-most) row contains dataset identifiers that uniquely identify a plurality of datasets. The first (leftmost) column contains pipeline identifiers that uniquely identify a plurality of pipelines. Most dataset-pipeline combinations (rows-column intersections, i.e., ‘cells’) have an accuracy score, though some do not. Lack of an accuracy score could be a result of lacking historical data for that dataset-pipeline combination, for instance. In examples, either no, or too few, runs were performed for that dataset-pipeline combination. There may be a threshold number of runs needed for a combination in order to account for an accuracy score for that combination, for instance. Additionally or alternatively, there may have been failures or other issued during one or more runs that might result in a missing accuracy score for a dataset-pipeline combination.

The process factors the matrix M of first accuracy scores into latent factors, specifically pipeline latent factors and dataset latent factors. In the example of FIG. 3B, matrix M 300b is factored into a collection W (a matrix in this example) of pipeline latent factors and a collection H (a matrix in this example) of dataset latent factors. Each matrix W. H is a two-dimensional matrix of factors that includes a plurality of factors for each instance (dataset or pipeline). Latent factors may sometimes be referred to as ‘latent features’ and ‘latent variables’, and are a known concept for describing the instances (e.g., pipelines or datasets as the case may be) in a manner projected into a latent space for a more compact representation. The idea, using the example of datasets, is that for two similar datasets, the latent factors of those two datasets are expected to be similar. In the same manner, the latent factors of similar pipelines are expected to be similar. The less similar a dataset (or pipeline) is to another dataset (or pipeline), the less similar (more distant) their latent factors are expected to be from each other relative to the latent factors of more similar datasets. The determination of these latent factors may be made automatically and programmatically.

An objective when a given dataset is presented may be to identify a pipeline, of the available pipelines, that is best to use to build an ML model based on the dataset. To help achieve this, aspects described herein augment the matrix of first accuracy scores (base accuracies) based on the given dataset, and do so with accuracies (‘second accuracy scores’, as updated accuracies) of the ML models produced from running the given dataset on a number of the available pipelines reflected by the matrix. The resulting (augmented) matrix is referred to herein as M′.

Initially, the process selects a subset of machine learning pipelines of the plurality of machine learning pipelines. The given dataset will eventually be run through this subset of pipelines, rather than each of the pipelines in the plurality of pipelines. In examples, the selecting selects k number of pipelines from M, where k is 1 or greater. The selection may be based on the first accuracy scores reflected in M and/or the determined latent factors, for examples. In a specific embodiment, the selected subset of pipelines includes the k highest-performing machine learning pipelines based on the accuracy scores of those machine learning pipelines with datasets of the plurality of datasets. In other words, a pipeline may be selected as one of the k highest performing by considering the accuracy score(s) produced from running one or more of the datasets through that pipeline. In examples, the accuracy scores considered for a given pipeline may be those of datasets that were identified based on their latent factors.

If the given dataset were to be run through each of the plurality of pipelines, this could be a tremendous waste of resources, particularly in situations where there are numerous available pipelines. Conversely, running the dataset through too few of the pipelines—say, just the top performing pipeline as reflected in M—might not adequately capture characteristics of the given dataset useful in picking the optimum pipeline for this given dataset as discussed below. k therefore may be a tunable parameter. This approach of selecting k pipelines has an advantage in that it provides the process a balanced starting point for trial pipeline runs using the new dataset, stemming this from the highest performing pipeline(s) as an early focus on the potentially optimal pipeline to ultimately select, and does this based on historical performance of the pipelines but without eliminating from consideration the non-selected pipelines.

For the given/new dataset, the process runs the subset of machine learning pipelines (k selected pipelines) with the new dataset to build and test respective ML models, and obtains second accuracy scores, these second accuracy scores being for combinations of the new dataset and the subset of selected machine learning pipelines. In this aspect, the new dataset is run through the k ML pipelines (perhaps iteratively to provide multiple runs for each pipeline). These runs produce ML models that may be tested to produce results, such as accuracy scores that are each an average of the accuracies across all runs through a given pipeline.

The process then augments the matrix of accuracy scores with the second accuracy scores reflected for the new dataset to produce an augmented matrix of accuracy scores (M′). M′ may therefore be constructed by adding these second accuracy scores as a new column to M, for example. Since the new dataset was not run through all of the pipelines reflected in M, there will be missing accuracy scores in the column for the new dataset.

At this point, M′ reflects accuracies of models produced for that new dataset using the k selected pipelines. One option is to take these second accuracy scores as they are and select one (or more) of the k pipelines, for instance the one (or more) that produce the most accurate ML model(s), and use that one (or more) to build respective ML model(s) using that new dataset.

Additionally or alternatively, an approach performs further analysis, for instance to identify, from the augmented set M′ of accuracy scores, dataset(s) that are similar to the new dataset, and performs sanity checks as a way to further evaluate the veracity of what is reflected by M′. This further analysis includes further matrix factorization, in examples. For instance, the process factors the augmented matrix M′ of accuracy scores into refined pipeline latent factors (W′) and refined dataset latent factors (H′). In examples, H′ and W′ may be initialized from the initial W and H factors discussed above.

With the augmented matrix, i.e., added column corresponding to the runs with the new dataset, the initial latent factors W and/or H may have been updated. In this regard, not only will dataset latent factors be determined for the new dataset, but dataset and/or pipeline latent factors of the pipelines and existing datasets might be updated based on this additional matrix factorization.

In general, it may be desired for the latent factors to be limited in length while remaining consistent with a goal that similar datasets (or pipelines) are expected to have similar latent factors. In this regard, the factoring of the augmented matrix of accuracy scores can include using an objective function that includes a loss function and regularization penalty to enforce constraints as part of this factorization. An advantage of using an objective function with a loss aspect and a regularization aspect enables a focus on reaching an overall objective while balancing loss and regularization.

In a specific example, the objective function for matrix factorization to determine W′ and H′ is given by: minimize [(MSE(M′, W′×H′)+Δ×(regularization penalty)], where MSE refers to the mean squared error loss function and lambda (λ) is a weight on a regularization penalty. The regularization penalty includes and is a function of a similarity term f(s,d) and a regularization term. The regularization term refers to any known technique of regularization with respect to machine learning models. Examples can include, but are not limited to, L1 regularization (“lasso regularization”), L2 regularization (“ridge regularization”), a function/composite of L2 and L1 (e.g., L1+L2) regularization, and others. In general, regularization is to avoid undesired fitting (overfitting, underfitting) in the models. It is noted that, with respect to the initial factorization above of matrix M for instance, optimization could be run with or without a regularization term and that, for the optimization, a stochastic gradient descent method or Adam optimizer approach could be used (as examples).

The similarity term f(s,d) is a function of (i) s, DatasetSimilarity, referring to dataset similarity between datasets and (ii) d, DistanceBetweenDatasetFactors, referring to a distance between latent factors of the refined dataset latent factors. Greater similarity as between datasets results in a lower latent factor distance and lesser similarity results in a higher latent factor distance under this scheme. In another words, the similarity term is expected to reflect that as dataset similarity(s) increases, distance (d) decreases, meaning the distance between the latent factors should be relatively low, and if the datasets are relatively different then the distance between their latent factors should be higher. An advantage of this is that it provides a check on the latent factors determined for the datasets to ensure consistency as between the latent factors when there is consistency (similarity) as between the datasets. Lack of similarity would result in a greater regularization penalty, which results in a relative increase in the result of the objective function, which desirably produces a higher value that is less likely to be the optimal result from the objective function.

In particular examples, the dataset similarity term(s) is determined using canonical correlation analysis (CCA). An advantage of using this well-known analysis is that it provides a straightforward assessment of dataset similarity. In addition, CCA is applicable even when two sets have different sets of columns/features, which is often the case with a disparate collection of historical datasets. In particular examples, the distance (d) between latent factors includes a Euclidean distance, an advantage of which is that it provides a straightforward way to compare latent factors involved.

The following provides an example function ƒ to operate on the s and d terms, i.e., as ƒ(s,d):

$$\begin{matrix}- d * {e}^{{β}_{1} s} , if s > 0.5 , for some {β}_{1} \geq 1 \\ \frac{{e}^{{β}_{2} ( 1 - s )}}{d} , if s \leq 0.5 , for some {β}_{2} \geq 1\end{matrix}$$

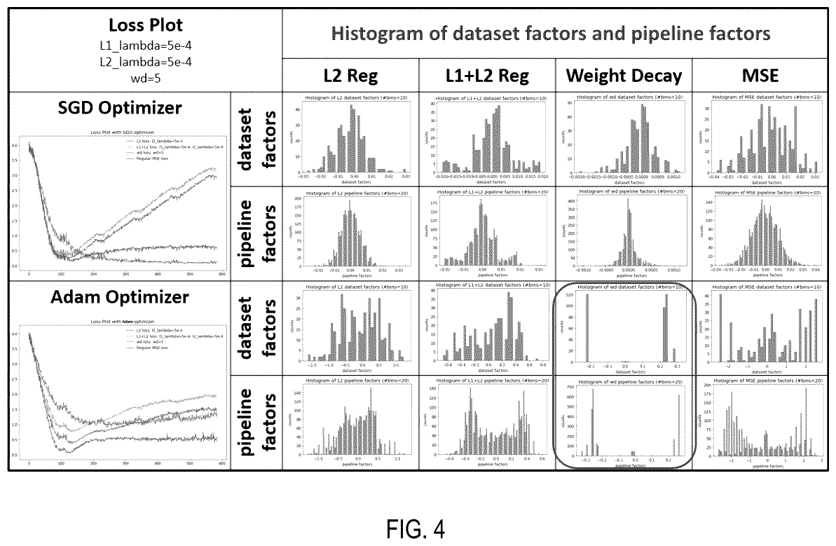

The factorization of an accuracy matrix such as M′ into dataset and pipeline latent factors could employ different optimizers for the optimization function, some of which might perform better than others. FIG. 4 depicts an example conceptual comparison of optimizer performance in factoring an accuracy matrix into dataset and pipeline latent factors, in accordance with aspects described herein. FIG. depicts various histograms (graphs) of dataset latent factors and pipeline latent factors for each of two known optimizers—the SGD optimizer and the Adam optimizer, both of which are iterative algorithms that process a dataset once, adjust parameters based on the loss, and iterate this processing and parameter adjustment until a minimum is reached (which leads to overfitting if continued). In each histogram of FIG. 4, the x-axis corresponds to the latent factors and the y-axis corresponds to the number of counts. In the example of FIG. 4, the weight decay loss stands out over L2 and L1+L2 loss, for instance, informing that the Adam optimizer is preferred as between these two optimizers, and this is to be used with weight decay as the regularization term. In some embodiments, optimizer and regularization term selection can be made based on historical performance, either manually or automatically, for instance by a trained AI model.

The objective function will determine the W′ and H′ latent factors such that the objective function is minimized. This produces the refined pipeline latent factors (W′) and refined dataset latent factors (H′), which can be used to augment M′, similar to the augmentation of M with H and W above, if desired.

The process can then identify, based on these refined pipeline latent factors and the refined dataset latent factors, at least one machine learning pipeline, of the plurality of machine learning pipelines, as being most optimal for model building based on the new dataset. Ultimately, for instance, the process might pick one pipeline to use, though in other examples the process selects and outputs more than one. The refined factors account for the performance of the k pipelines using the new dataset and therefore present a more complete picture of pipeline performances and latent factors of those performances. An advantage in the processing described to select these one or more pipelines from the available pipelines is that it can identify with relative ease based on historical data and selected pipeline runs on a new dataset optimal pipeline options to use for the new dataset and selection of a best pipeline therefrom. It is cost/resource-prohibitive to try all pipelines in many situations. By using latent factors that identify similar datasets to the new dataset and pipeline factors that identify/verify that similar pipelines perform similarly, the pipelines that perform best for datasets most similar (informed by the latent factors) to the new dataset can be expected to perform best for the new dataset, which thereby identifies pipeline(s) that are most optimal for model building based on the new dataset.

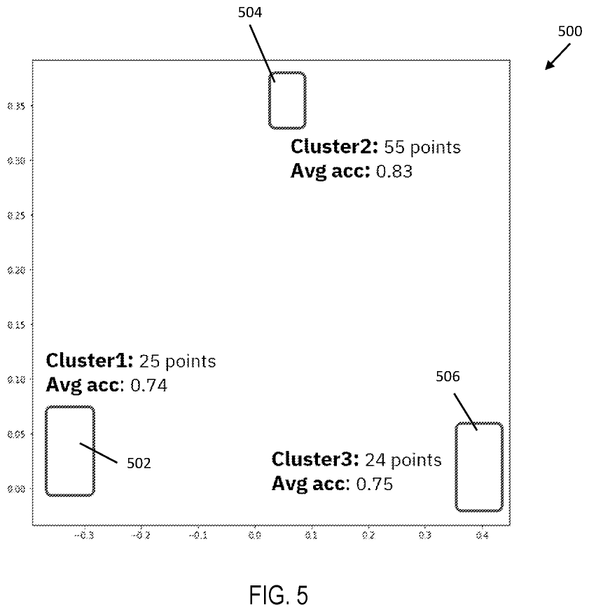

Further analysis can be performed to inform of and verify similarities between pipelines, providing a kind of sanity check on a proposed solution of one or more pipelines. For instance, FIG. 5 depicts an example clustering of pipelines based on performance to conceptually inform of and verify similarities between pipelines, in accordance with aspects described herein. In FIG. 5, the graph 500 provides a representation of 100 pipelines based on principal clustering analysis (PCA) using two PCA components (along with 4 pipelines with 3 or 4 PCA components). The Adam optimizer with weight decay was used for the optimization. The number of latent factors for each pipeline was 3 and this resulted in three clusters of pipelines. All pipelines with 1 step are in cluster 1, while all pipelines with 2 steps are in cluster 2, and pipelines with 3 or 4 steps are in cluster 3. Similar pipelines have similar accuracy, look similar to each other, and are clustered. While such clustering to perform a sanity check is not required, it can be a practical and useful tool to data scientists in order to inform and verify consistency between similar pipelines and the clustered accuracies. Same/similar clustering approaches or other desired sanity checking can be performed for dataset clustering to provide an advantage in that they verify, for instance, which dataset(s) are most similar to the new dataset for a pipeline that is to be selected.

A selected pipeline can be indicated to a user or system for actual running of the selected pipeline on the new dataset. Additionally or alternatively, the process can further include building and outputting a machine learning model using such a selected machine learning pipeline (of the at least one machine learning pipeline selected). Providing the additional task of generating an ML model based on an identified optimum pipeline has advantages because the generation of the ML model may be heavy lift computationally and/or provide additional optimization opportunities through tailoring pipeline parameters or similar actions to actually build and provide the ML model.

Additionally or alternatively, a user or other entity could determine a number of best/optimum pipeline and/or the k number of pipelines depending on an available time and compute budget (or other parameters) that might affect the ability to run candidate pipeline(s) on the dataset at hand. A selection of the best/optimum pipeline that produces the best (most accurate) ML model could therefore be based on a time and compute budget. In a specific example, the identified at least one machine learning pipeline is based on the time and compute budget, as maybe the ‘best’ pipeline in terms of raw accuracy is too expensive to run for the given application, in this situation, the second ‘best’ pipeline may be the only feasible pipeline for the application, thereby providing the ‘optimal’ pipeline for that application. This approach has an advantage in that it enables the process to account for the varying costs to run the different pipelines in terms of time and/or compute resources, and better identify what is/are the ‘optimum’ pipeline(s) as a function of not only pipeline accuracy but also the available time/compute resources for the particular task.

Aspects of the above can be re-performed each time a new dataset is presented. In other words, a new M′ can be built and augmented, a known best optimizer and regularization approach for the regularization can be performed to optimize the refined latent factoring, and then the best pipeline(s) can be selected.

Aspects described herein differ from other approaches for identifying an ML pipeline, for instance an approach that relies on an assumption of a Dirac delta distribution over a probability of choosing a pipeline for a dataset conditioned on how the pipeline performed on the dataset, then multiplying that probability with a value of the regret (loss of accuracy) of choosing the pipeline on the dataset to get an expected regret. The expected regret of choosing the best pipelines of one dataset for another dataset becomes the distance between the two datasets, and a clustering step is performed in the space of these distances. Pipelines for a new dataset are recommended based on the best pipelines for the representative dataset of the cluster the new dataset is close to in that space. In contrast, aspects described herein present approaches for determining expected performance values of one or more ML pipelines on a dataset based on partial availability of performance values of a (sub)set of the pipelines on a (sub)set of historical datasets. The performance values may be partially available in the sense that data for some dataset-pipelines may be lacking (though runs of those dataset-combinations could be performed if desired, but this is not a requirement). Under these approaches, the performance values are arranged in a matrix that is factored in such a way that the factors reconstruct the known values of the matrix with minimal error when multiplied and one set of the factors (i.e., the dataset factors) have inter-factor distances reflecting the “closeness” of the corresponding datasets. Similarity in the latent factors of two datasets informs that the two datasets are similar. Aspects utilize canonical correlation analysis (as one example) for determining similarity of datasets, and a similarity score is combined with inter-factor distances in a function such that similar datasets have relatively close inter-factor distances and dissimilar datasets have relatively high inter-factor distances. The accuracies of datasets similar to the new dataset, as informed by the refine latent factors, can inform pipelines that are expected to perform well for the new dataset, and in this regard the best pipelines selected for the new dataset can be those that are reflected as being the best for the datasets most similar to the new dataset.

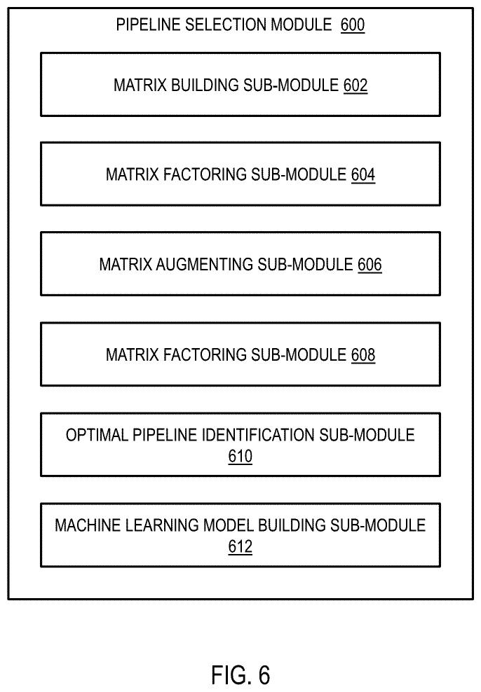

FIG. 6 depicts further details of an example pipeline selection module (e.g., pipeline selection module 600 of FIG. 1) to incorporate and/or use aspects described herein. In one or more aspects, pipeline selection module 600 includes, in one example, various sub-modules to be used to perform ML pipeline selection for use in building machine learning model(s). The sub-modules can be or include, e.g., computer readable program code (e.g., instructions) in computer readable media, e.g., persistent storage (e.g., persistent storage 113, such as a disk) and/or a cache (e.g., cache 121), as examples. The computer readable media may be part of a computer program product and may be executed by and/or using one or more computers or devices, and/or processor(s) or processing circuitry thereof, such as computer(s) 101, EUD 103, server 104, or computers of cloud 105/106 of FIG. 1, as examples.

Referring to FIG. 6, pipeline selection module 600 includes (i) a matrix building sub-module 602 that builds, from performed cross-validation runs for a plurality of dataset-pipeline combinations combined from a plurality of datasets and a plurality of machine learning pipelines, a matrix M of accuracy scores, the accuracy scores being first accuracy scores that include a respective accuracy score for each dataset-pipeline combination of the plurality of dataset-pipeline combinations, (ii) a matrix factoring sub-module 604 for factoring the matrix M of accuracy scores into pipeline latent factors W and dataset latent factors H. (iii) a matrix augmenting sub-module 606 for augmenting the matrix M of accuracy scores, in which a subset of machine learning pipelines of the plurality of machine learning pipelines are selected and run with the new dataset to build and test respective machine learning models and obtain second accuracy scores for combinations of the new dataset and the subset of machine learning pipelines, and the matrix M of accuracy scores is augmented with the second accuracy scores reflected for the new dataset to produce the augmented matrix M′ of accuracy scores, (iv) a matrix factoring sub-module 608 (which could be the same sub-module as 604 or a different sub-module) for factoring the augmented matrix M′ of accuracy scores into refined pipeline latent factors W′ and refined dataset latent factors H′, (v) an optimal pipeline identification sub-module 610 for identifying, based on the refined pipeline latent factors W′ and the refined dataset latent factors H′, at least one machine learning pipeline, of the plurality of machine learning pipelines, as most optimal for model building based on the new dataset, and (vi) a machine learning model building sub-module 612 for building and outputting a machine learning model using a selected machine learning pipeline of the at least one machine learning pipeline.

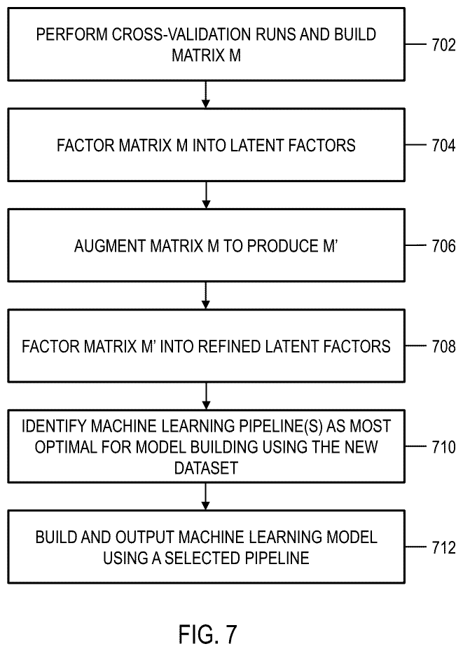

FIG. 7 depicts an example process for selecting machine learning pipeline(s) for use in building machine learning model(s), in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 7 are part of a module, such as module 600. In other examples, the code may be included in one or more modules and/or in one or more sub-modules of the one or more modules. Various options are available.

The process of FIG. 7 begins at 702 by performing cross-validation runs for a plurality of dataset-pipeline combinations combined from a plurality of datasets and a plurality of machine learning pipelines, and building from the cross-validation runs a matrix of accuracy scores. The accuracy scores are first accuracy scores and include a respective accuracy score for each dataset-pipeline combination of the plurality of dataset-pipeline combinations. The process factors (704) the matrix of accuracy scores into pipeline latent factors and dataset latent factors, and augments (706) the matrix of accuracy scores. The augmenting 706 includes, for example, selecting a subset of machine learning pipelines of the plurality of machine learning pipelines, then for a new dataset, running the subset of machine learning pipelines with the new dataset to build and test respective machine learning models, and obtain second accuracy scores for combinations of the new dataset and the subset of machine learning pipelines, and then augmenting the matrix of accuracy scores with the second accuracy scores reflected for the new dataset to produce an augmented matrix M′ of accuracy scores.

The selected subset of machine learning pipelines includes, for instance, k highest-performing machine learning pipelines based on the accuracy scores of combinations of those machine learning pipelines with datasets of the plurality of datasets. An approach of selecting k pipelines has an advantage in that it provides the process a balanced starting point for trial pipeline runs using a new dataset, stemming this from the highest performing pipeline(s) as an early focus on the potentially optimal pipeline to ultimately select, and does this based on historical performance of the pipelines but without eliminating from consideration the non-selected pipelines.

The process of FIG. 7 continues by factoring (708) the augmented matrix M′ of accuracy scores into refined pipeline latent factors and refined dataset latent factors. In particular examples, factoring the augmented matrix M′ of accuracy scores includes using an objective function that includes a loss function and regularization penalty. Using an objective function with a loss aspect and a regularization aspect in that has an advantage in that it enables a focus on reaching an overall objective while balancing loss and regularization. In examples, the regularization penalty includes a similarity term and the similarity term is a function of (i) dataset similarity between datasets and (ii) distance between latent factors of the refined dataset latent factors, where greater similarity results in a lower latent factor distance and lesser similarity results in a higher latent factor distance. This has an advantage in that it provides a check on the latent factors determined for the datasets to ensure consistency as between the latent factors when there is consistency (similarity) as between the datasets. In examples, the dataset similarity is determined using canonical correlation analysis which has an advantage of using a well-known analysis that provides a straightforward assessment of dataset similarity even when the number of columns/features is different for the datasets being compared. In examples, the distance between latent factors includes (is determined as) a Euclidean distance, which has an advantage in that it provides a straightforward way to compare latent factors involved.

Continuing with FIG. 7, the process identifies (710), based on the refined pipeline latent factors and the refined dataset latent factors, at least one machine learning pipeline, of the plurality of machine learning pipelines, as most optimal for model building based on the new dataset. In examples, the identifying the at least one machine learning pipeline includes validating results for the at least one machine learning pipeline. The validating the results includes at least one selected from the group consisting of: clustering the plurality of machine learning pipelines into pipeline clusters and verifying similarity of clustered pipelines, and clustering the plurality of datasets and new dataset into dataset clusters and verifying similarity of clustered datasets. Same/similar clustering approaches (or other desired sanity checking) can be performed for dataset clustering to provide an advantage in that they verify, for instance, which dataset(s) are most similar to the new dataset for a pipeline is to be selected.

FIG. 7 then proceeds by building and outputting (712) a machine learning model using a selected machine learning pipeline of the at least one machine learning pipeline. The additional task of building and outputting the ML model has advantages in that such generation of the ML model may be difficult computationally or otherwise, and/or it provides additional optimization opportunities, for instance through tailoring pipeline parameters or similar actions to build and provide the ML model, which may not fit within the expertise of an entity requesting the ML model based on the new dataset, which might have been provided by that entity. In some examples, the selected machine learning pipeline is selected based on a time and compute budget. This has an advantage in that it enables the process to account for the varying costs to run the different pipelines in terms of time and/or compute resources, and better identify what is/are the ‘optimum’ pipeline(s) as a function of not only pipeline accuracy but also the available time/compute resources for the particular task.

The process of FIG. 7 for selecting machine learning pipeline(s) for use in building machine learning model(s) has an advantage in that it identifies with relative ease based on historical data and selected pipeline runs on a new dataset optimal pipeline options to use for the new dataset and selection of a best pipeline therefrom, which avoids the potentially cost/resource-prohibitive task of running the dataset through all available pipelines to determine an optimal one to use.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
performing cross-validation runs for a plurality of dataset-pipeline combinations combined from a plurality of datasets and a plurality of machine learning pipelines, and building from the cross-validation runs a matrix of accuracy scores, the accuracy scores being first accuracy scores, including a respective accuracy score for each dataset-pipeline combination of the plurality of dataset-pipeline combinations;
factoring the matrix of accuracy scores into pipeline latent factors and dataset latent factors;
augmenting the matrix of accuracy scores, the augmenting comprising:
selecting a subset of machine learning pipelines of the plurality of machine learning pipelines;
for a new dataset, running the subset of machine learning pipelines with the new dataset to build and test respective machine learning models, and obtaining second accuracy scores for combinations of the new dataset and the subset of machine learning pipelines; and
augmenting the matrix of accuracy scores with the second accuracy scores reflected for the new dataset to produce an augmented matrix of accuracy scores;
factoring the augmented matrix of accuracy scores into refined pipeline latent factors and refined dataset latent factors; and
identifying, based on the refined pipeline latent factors and the refined dataset latent factors, at least one machine learning pipeline, of the plurality of machine learning pipelines, as most optimal for model building based on the new dataset.

2. The method of claim 1, wherein the selected subset of machine learning pipelines comprises k highest-performing machine learning pipelines based on the accuracy scores of combinations of those machine learning pipelines with datasets of the plurality of datasets.

3. The method of claim 1, wherein the factoring the augmented matrix of accuracy scores comprises using an objective function that includes a loss function and regularization penalty.

4. The method of claim 3, wherein the regularization penalty comprises a similarity term, the similarity term being a function of (i) dataset similarity between datasets and (ii) distance between latent factors of the refined dataset latent factors, wherein greater similarity results in a lower latent factor distance and lesser similarity results in a higher latent factor distance.

5. The method of claim 4, wherein the dataset similarity is determined using canonical correlation analysis.

6. The method of claim 4, wherein the distance between latent factors comprises a Euclidean distance.

7. The method of claim 1, further comprising building and outputting a machine learning model using a selected machine learning pipeline of the at least one machine learning pipeline.

8. The method of claim 7, further comprising selecting the selected machine learning pipeline based on a time and compute budget.

9. The method of claim 1, wherein the identifying the at least one machine learning pipeline comprises validating results for the at least one machine learning pipeline, the validating the results comprising at least one selected from the group consisting of:
clustering the plurality of machine learning pipelines into pipeline clusters and verifying similarity of clustered pipelines; and
clustering the plurality of datasets and new dataset into dataset clusters and verifying similarity of clustered datasets.

10. A computer system comprising:
a memory; and
a processor in communication with the memory, wherein the computer system is configured to perform a method comprising:
performing cross-validation runs for a plurality of dataset-pipeline combinations combined from a plurality of datasets and a plurality of machine learning pipelines, and building from the cross-validation runs a matrix of accuracy scores, the accuracy scores being first accuracy scores, including a respective accuracy score for each dataset-pipeline combination of the plurality of dataset-pipeline combinations;
factoring the matrix of accuracy scores into pipeline latent factors and dataset latent factors;
augmenting the matrix of accuracy scores, the augmenting comprising:
selecting a subset of machine learning pipelines of the plurality of machine learning pipelines;
for a new dataset, running the subset of machine learning pipelines with the new dataset to build and test respective machine learning models, and obtaining second accuracy scores for combinations of the new dataset and the subset of machine learning pipelines; and
augmenting the matrix of accuracy scores with the second accuracy scores reflected for the new dataset to produce an augmented matrix of accuracy scores;
factoring the augmented matrix of accuracy scores into refined pipeline latent factors and refined dataset latent factors; and
identifying, based on the refined pipeline latent factors and the refined dataset latent factors, at least one machine learning pipeline, of the plurality of machine learning pipelines, as most optimal for model building based on the new dataset.

11. The computer system of claim 10, wherein the factoring the augmented matrix of accuracy scores comprises using an objective function that includes a loss function and regularization penalty.

12. The computer system of claim 11, wherein the regularization penalty comprises a similarity term, the similarity term being a function of (i) dataset similarity between datasets and (ii) distance between latent factors of the refined dataset latent factors, wherein greater similarity results in a lower latent factor distance and lesser similarity results in a higher latent factor distance.

13. The computer system of claim 10, wherein the method further comprises building and outputting a machine learning model using a selected machine learning pipeline of the at least one machine learning pipeline.

14. The computer system of claim 13, wherein the method further comprises selecting the selected machine learning pipeline based on a time and compute budget.

15. The computer system of claim 10, wherein the identifying the at least one machine learning pipeline comprises validating results for the at least one machine learning pipeline, the validating the results comprising at least one selected from the group consisting of:
clustering the plurality of machine learning pipelines into pipeline clusters and verifying similarity of clustered pipelines; and
clustering the plurality of datasets and new dataset into dataset clusters and verifying similarity of clustered datasets.

16. A computer program product comprising:
a computer readable storage medium readable by a processing circuit and storing instructions for execution by the processing circuit to:
performing cross-validation runs for a plurality of dataset-pipeline combinations combined from a plurality of datasets and a plurality of machine learning pipelines, and building from the cross-validation runs a matrix of accuracy scores, the accuracy scores being first accuracy scores, including a respective accuracy score for each dataset-pipeline combination of the plurality of dataset-pipeline combinations;
factoring the matrix of accuracy scores into pipeline latent factors and dataset latent factors;
augmenting the matrix of accuracy scores, the augmenting comprising:
selecting a subset of machine learning pipelines of the plurality of machine learning pipelines;
for a new dataset, running the subset of machine learning pipelines with the new dataset to build and test respective machine learning models, and obtaining second accuracy scores for combinations of the new dataset and the subset of machine learning pipelines; and
augmenting the matrix of accuracy scores with the second accuracy scores reflected for the new dataset to produce an augmented matrix of accuracy scores;
factoring the augmented matrix of accuracy scores into refined pipeline latent factors and refined dataset latent factors; and
identifying, based on the refined pipeline latent factors and the refined dataset latent factors, at least one machine learning pipeline, of the plurality of machine learning pipelines, as most optimal for model building based on the new dataset.

17. The computer program product of claim 16, wherein the factoring the augmented matrix of accuracy scores comprises using an objective function that includes a loss function and regularization penalty.

18. The computer program product of claim 17, wherein the regularization penalty comprises a similarity term, the similarity term being a function of (i) dataset similarity between datasets and (ii) distance between latent factors of the refined dataset latent factors, wherein greater similarity results in a lower latent factor distance and lesser similarity results in a higher latent factor distance.

19. The computer program product of claim 16, wherein the method further comprises building and outputting a machine learning model using a selected machine learning pipeline of the at least one machine learning pipeline.

20. The computer program product of claim 19, wherein the method further comprises selecting the selected machine learning pipeline based on a time and compute budget.
